(19) United States
(12) Patent Application Publication
(10) Pub. No.: US 2022/0297840 A1
(43) Pub. Date: Sep. 22, 2022

(54) VENTILATION CONTROL SYSTEM FOR AN AIRCRAFT

(71) Applicant: The Boeing Company, Chicago, IL (US)

(72) Inventors: Richa Talwar, Bengaluru (IN); Khilendra Singh, Bengaluru (IN); Vijay Bhaskar Damodaran, Bengaluru (IN); Vinay Kumar Doddamane, Bengaluru (IN)

(73) Assignee: The Boeing Company, Chicago, IL (US)

(21) Appl. No.: 17/541,378

(22) Filed: Dec. 3, 2021

Related U.S. Application Data
(60) Provisional application No. 63/162,783, filed on Mar. 18, 2021.

(51) Int. Cl. B64D 11/00; B64D 13/06; B64D 11/06

(52) U.S. Cl. CPC B64D 11/00151; B64D 13/06; B64D 11/0624; B64D 11/00155; B64D 2013/003

(57) ABSTRACT

A ventilation control system for controlling airflow in an aircraft cabin includes a plurality of controllable ventilation valves associated with a plurality of passenger seats. User interfaces are arranged to individually control the controllable ventilation valves. A control panel is in communication with the controllable ventilation valves, wherein the control panel is arranged to concurrently control the plurality of controllable ventilation valves.

### CROSS-REFERENCE TO RELATED APPLICATIONS

This application claims the benefit of U.S. Provisional Patent Application No. 63/162,783 filed on Mar. 18, 2021, the disclosure of which is hereby incorporated by reference.

### TECHNICAL FIELD

The present disclosure is generally related to aircraft passenger service units and, more particularly, to an individualized ventilation control system and associated apparatus for use in an aircraft.

### BACKGROUND

Passenger service units are found in commercial or passenger aircraft above the rows of seats and are used to provide various service functions to passengers. These service functions are provided by air ventilation valves, reading lights, illuminated display symbols, and flight attendant call lamps. The air ventilation valves, reading lights, illuminated display symbols, and flight attendant call lamps may be arranged in an overhead directional service unit. The controls for the reading lights, illuminated display symbols, and flight attendant call lamps may be disposed on a service panel of the passenger service unit that is within reach of the passenger, either in an armrest, an in-flight entertainment system, or above the seats. The air ventilation valves are manually controllable.

The air ventilation valves may be gasper valves, which are individual, adjustable outlet vents for cabin ventilation. The gasper valve may include small, circular vents that are arranged above each passenger seat and may be manually adjustable by passengers for personal comfort. The manual control may include a revolving control on the vent that may be twisted to adjust ventilation between a zero flow state and a maximum flow. Gasper valves receive pressurized air from air conditioning packs aboard the aircraft, which in turn receive compressed, clean air from the compressor stages of the aircraft's jet engines in one embodiment. A master control for an air supply that is coupled to the gasper valves may be located in the cockpit or in a service area, allowing air flow to the gasper valves to be turned off during certain phases of flight, to minimize the load on the engines from bleed-air demands.

There may be benefits to being able to remotely control some or all of the air ventilation valves to open states or fully closed states in flight or during service between flights.

### SUMMARY

A ventilation control system for controlling airflow in an aircraft cabin includes a plurality of controllable ventilation valves that are associated with a plurality of passenger seats. User interfaces are arranged to individually control the controllable ventilation valves. An aircraft service control panel is in communication with the controllable ventilation valves and is arranged to concurrently control the plurality of controllable ventilation valves.

An aspect of the disclosure includes the plurality of user interfaces being accessible on a personal electronic device, an in-flight entertainment system, or a seat control panel to individually control the plurality of controllable ventilation valves.

Another aspect of the disclosure includes each of the plurality of user interfaces being coupled via a communication bus to a respective one of the plurality of controllable ventilation valves.

Another aspect of the disclosure includes each of the plurality of user interfaces being wirelessly coupled to a respective one of the plurality of controllable ventilation valves.

Another aspect of the disclosure includes each of the plurality of controllable ventilation valves including a moveable flow valve disposed in a valve body including a nozzle and a first actuator connected to the moveable flow valve, wherein the first actuator is arranged to control a position of the moveable flow valve in relation to the valve body.

Another aspect of the disclosure includes a second actuator being arranged to provide directional control of the nozzle.

Another aspect of the disclosure includes each of the plurality of user interfaces being arranged to communicate with a personal electronic device.

Another aspect of the disclosure includes the aircraft service control panel being arranged to concurrently control the plurality of controllable ventilation valves to open states.

Another aspect of the disclosure includes the aircraft service control panel being arranged to concurrently control the plurality of controllable ventilation valves to closed states.

Another aspect of the disclosure includes the aircraft service control panel being disposed in a service area of the aircraft cabin.

Another aspect of the disclosure includes the aircraft service control panel being disposed in a service area of the aircraft that is externally accessible.

Another aspect of the disclosure includes a ventilation control system for controlling airflow in an aircraft cabin that includes a plurality of controllable ventilation valves and a control panel. The controllable ventilation valves are associated with a plurality of passenger seats, and the control panel is in communication with the plurality of controllable ventilation valves. The control panel is arranged to concurrently control the plurality of controllable ventilation valves.

Another aspect of the disclosure includes each of the plurality of controllable ventilation valves having a moveable flow valve disposed in a valve body including a nozzle and an electro-mechanical actuator connected to the moveable flow valve. The electro-mechanical actuator is arranged to control a position of the moveable flow valve in relation to the valve body to control an orifice opening between the moveable flow valve and the valve body.

Another aspect of the disclosure includes the control panel being arranged to concurrently control the plurality of controllable ventilation valves to fully-opened states.

Another aspect of the disclosure includes the control panel being arranged to concurrently control the plurality of controllable ventilation valves to closed, no-flow states.

The above summary is not intended to represent every possible embodiment or every aspect of the present disclosure. Rather, the foregoing summary is intended to exemplify some of the novel aspects and features disclosed herein. The above features and advantages, and other features and advantages of the present disclosure, will be readily apparent from the following detailed description of representative embodiments and modes for carrying out the present disclosure when taken in connection with the accompanying drawings and the appended claims.

### BRIEF DESCRIPTION OF THE DRAWINGS

One or more embodiments will now be described, by way of example, with reference to the accompanying drawings, in which:

FIG. 1 schematically illustrates a perspective view of a portion of a cabin area of an aircraft, in accordance with the disclosure.

FIG. 2 schematically illustrates a ventilation control system for an aircraft, in accordance with the disclosure.

FIG. 3 schematically illustrates an embodiment of a controllable ventilation valve for an aircraft, in accordance with the disclosure.

FIG. 4 pictorially illustrates an embodiment of a user interface for a ventilation control system for an aircraft, in accordance with the disclosure.

The appended drawings are not necessarily to scale and may present a somewhat simplified representation of various preferred features of the present disclosure as disclosed herein, including, for example, specific dimensions, orientations, locations, and shapes. Details associated with such features will be determined in part by the particular intended application and use environment.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. It should be understood that throughout the drawings and specification, corresponding reference numerals indicate like or corresponding parts and features.

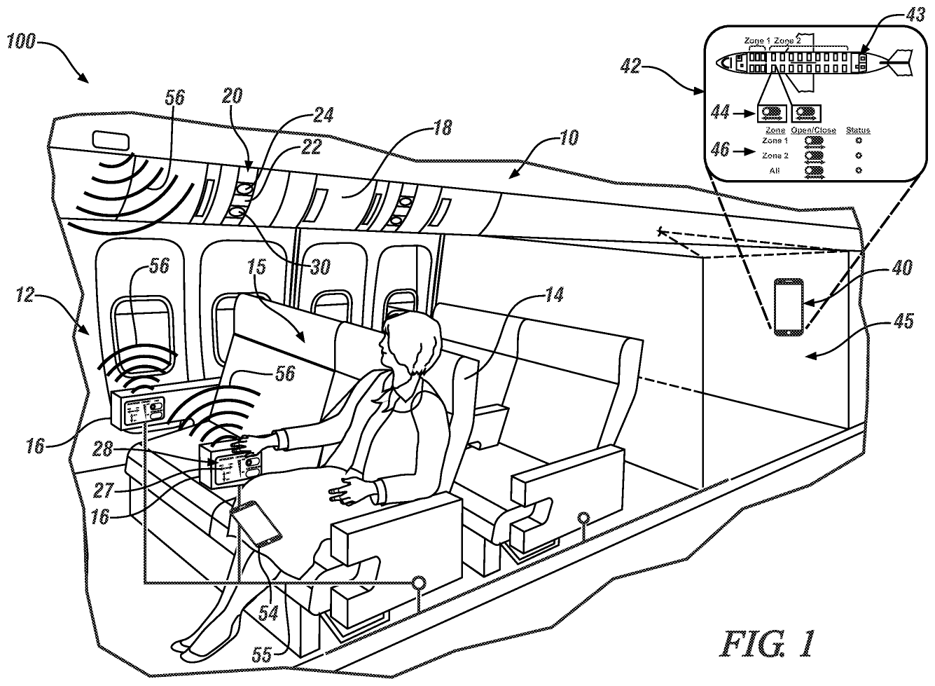

FIG. 1 illustrates a perspective view of a portion of a cabin 10 of an aircraft 100, including an outer wall portion 12, a passenger area 15, and a service area 45. The passenger area 15 may be separated from the service area 45 by a bulkhead wall in one embodiment. The passenger area 15 is intended for use by passengers during a flight. The service area 45 is intended for use by flight attendants during a flight, and for use by aircraft service personnel between flights. Alternatively, or in addition, there may be a second service area (not shown) that is located outside of the cabin 10 and is accessible to service personnel under conditions such as when the aircraft 100 is parked.

The passenger area 15 includes a plurality of passenger seats 14, each having an associated armrest 16, and one or multiple overhead compartments 18.

The overhead compartments 18 include a plurality of passenger service panels 20 in one embodiment. Each of the passenger service panels 20 includes one or multiple controllable ventilation valves 30, one or multiple reading lamps 22, one or multiple service call lamps 24, etc., wherein one of the controllable ventilation valves 30, one of the reading lamps 22, and one of the service call lamps 24 are associated with and correspond to one of the passenger seats 14. Alternatively, the passenger service panels 20 may be located elsewhere in the passenger area 15.

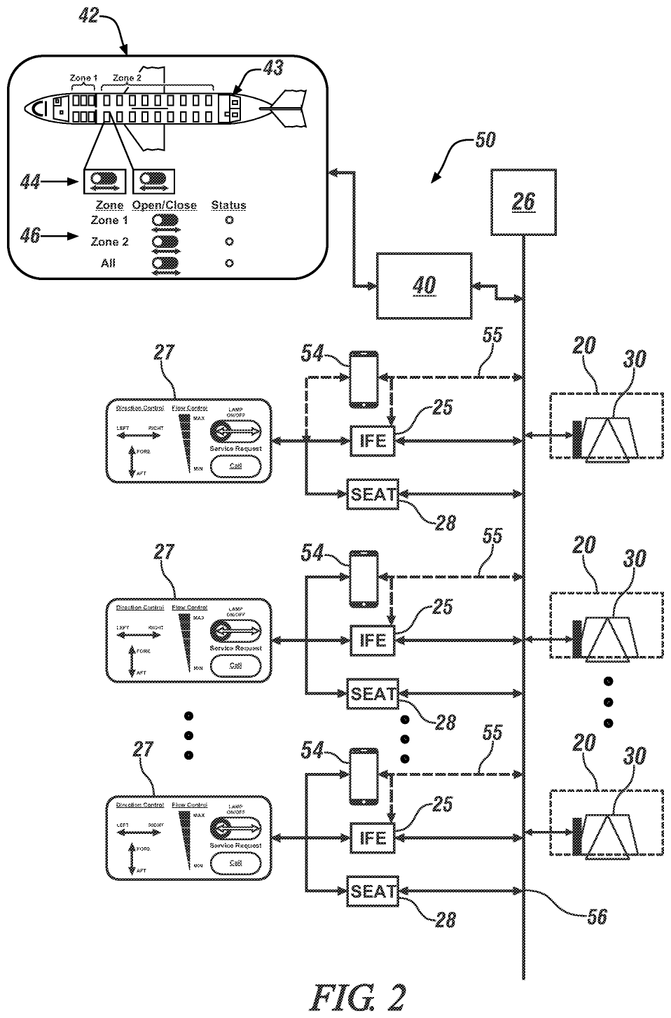

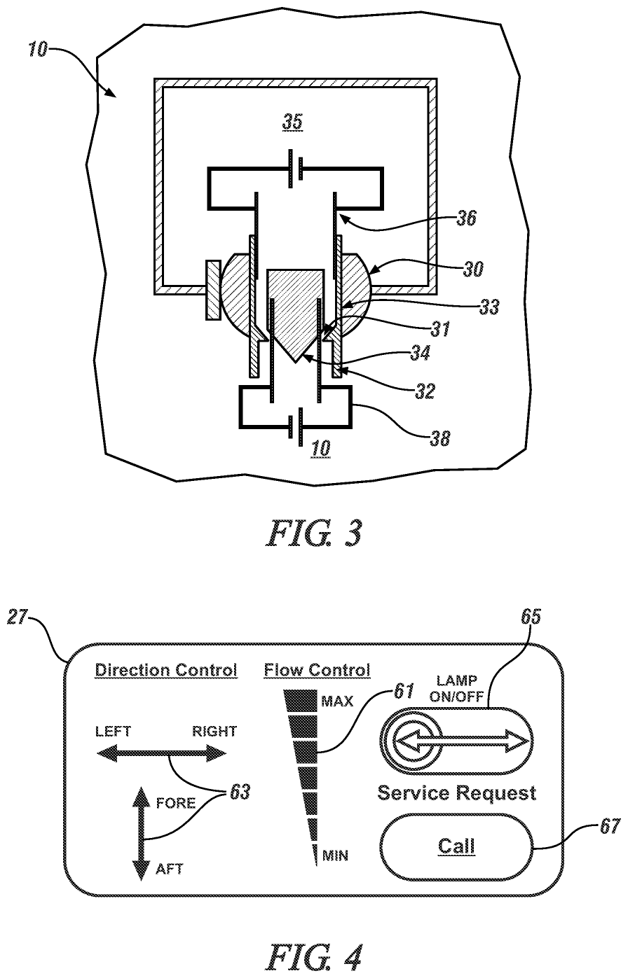

The controllable ventilation valves 30 are elements of a ventilation control system 50. Details related to an embodiment of the ventilation control system 50 are described with reference to FIG. 2. Details related to an embodiment of one of the controllable ventilation valves 30 is described with reference to FIG. 3.

Each of the plurality of passenger service panels 20 is controllable by a user interface 27. Details related to an embodiment of one of the user interfaces 27 is described with reference to FIG. 4. The user interface 27 may be accessible to a passenger via a seat control panel 28, an IFE (in-flight entertainment) system 25, and/or a personal electronic device 54, which are arranged to communicate with a passenger service panel (PSP) controller 26. The PSP controller 26 is in communication with and controls the elements of the passenger service panel 20.

The user interfaces 27 correspond to respective passenger seats 14, and are arranged to provide individual control to a corresponding one of the passenger service panels 20. In one embodiment, the user interfaces 27 and seat control panels 28 are disposed in the armrests 16 of the passenger seats 14. Alternatively, the user interfaces 27 may be disposed on seatbacks of the passenger seats 14 as part of the IFE system 25. Alternatively, or in addition, the user interfaces 27 may be arranged as software applications with an associated Graphical User Interface (GUI) that may be downloaded onto a passenger's personal electronic device 54. A passenger is able to control elements of one of the passenger service panels 20 that corresponds to their passenger seat 14 employing the respective user interface 27, either via the respective seat control panel 28 or their personal electronic device 54, including controlling the controllable ventilation valve 30, the reading lamp 22, and the service call lamp 24. Stated differently, each of the user interfaces 27 is arranged to control a corresponding controllable ventilation valve 30, reading lamp 22, and service call lamp 24 in response to a directive from a passenger in a respective one of the passenger seats 14.

The user interfaces 27 are in communication with the plurality of passenger service panels 20 via a communication bus 56 in one embodiment.

Alternatively, the user interfaces 27 are in communication with the plurality of passenger service panels 20 via a wireless local area network (WLAN) 55 in one embodiment.

The service area 45 is disposed in the cabin 10, and may be adjacent to or remotely located from the passenger area 15. The service area 45 may be arranged as a galley area in which flight attendants store and access food, beverages, pillows, blankets, and other elements to provide for passenger refreshments and comfort. The service area 45 also includes an aircraft service control panel 40 including an aircraft service interface 42 for operating the ventilation control system 50.

As used herein, the term “system” may refer to one of or a combination of actuators, sensors, controllers, application-specific integrated circuits (ASIC), combinatorial logic circuits, software, firmware, and/or other components that are arranged to provide the described functionality.

Referring again to FIG. 2, an embodiment of the ventilation control system 50 includes the plurality of passenger service panels 20 having controllable ventilation valves 30, the PSP controller 26, the plurality of user interfaces 27, the aircraft service control panel 40, and the aircraft service interface 42, all of which are disposed in the cabin 10. In one embodiment, the plurality of the user interfaces 27 are accessible to a passenger in the respective passenger seat 14 to command operation of elements of the respective passenger service panel 20, including commanding operation of the respective controllable ventilation valve 30.

This includes one of the user interfaces 27 being accessible to a passenger via the respective seat control panel 28, which is in communication with one of the plurality of the controllable ventilation valves 30 to individually control operation thereof, via the communication bus 56 or via the WLAN 55.

Alternatively or in addition, this includes one of the user interfaces 27 being accessible to a passenger via the respective IFE system 25, which is in communication with one of the plurality of the controllable ventilation valves 30 to individually control operation thereof, via the communication bus 56 or via the WLAN 55.

Alternatively or in addition, his includes one of the user interfaces 27 being accessible to a passenger via their personal electronic device 54, which is in communication with one of the plurality of the controllable ventilation valves 30 to individually control operation thereof, via the communication bus 56 or via the WLAN 55.

The aircraft service control panel 40 is in communication with all of the controllable ventilation valves 30 to concurrently control operation thereof.

In one embodiment, the plurality of controllable ventilation valves 30 is arranged into a plurality of zones, which may be associated with zones or areas in the cabin 10. In this arrangement, subsets of the controllable ventilation valves 30 contained in each of the zones of the cabin 10 are identified.

The aircraft service user interface 42 is in communication with the aircraft service control panel 40 to concurrently control operation of all of the controllable ventilation valves 30. The aircraft service user interface 42 includes a cabin layout 43, which pictorially provides a layout of the cabin area including depicting individual seats and zones (e.g., Zone 1, Zone 2), cockpit, and service area(s). Individual ventilation control icons 44, two of which are illustrated, correspond to individual ones of the controllable ventilation valves 30, and are arranged to provide individual activation and deactivation thereof. The aircraft service user interface 42 includes zone icons (Zone 1, Zone 2) and all-cabin icons (All) 46. The zone icons and all-cabin icons 46 are arranged to control activation and deactivation of a subset of the controllable ventilation valves 30, e.g., within one or multiple zones in the cabin (Zone 1, Zone 2). The zone icons and all-cabin icons 46 are arranged to control activation and deactivation of all of the controllable ventilation valves 30.

In one embodiment, concurrently controlling operation of the controllable ventilation valves 30 includes concurrently controlling all of the controllable ventilation valves 30 to a fully opened state. This may occur, for example, when a service person is seeking to purge the ventilation system.

In one embodiment, concurrently controlling operation of the controllable ventilation valves 30 includes concurrently controlling all of the controllable ventilation valves 30 to a fully closed state.

In one embodiment, the aircraft service control panel 40 may be configured to override commands from the plurality of user interfaces 27, either in-flight or on the ground. In this arrangement, the aircraft service control panel 40 may override commands from passengers to control one of the controllable ventilation valves 30, all of the controllable ventilation valves 30 in one of the zones, or all of the controllable ventilation valves 30 in the cabin 10 to a fully closed state. In this arrangement, the aircraft service control panel 40 may override commands from passengers to control one of the controllable ventilation valves 30, all of the controllable ventilation valves 30 in one of the zones, or all of the controllable ventilation valves 30 in the cabin 10 a fully opened state.

Referring now to FIG. 3, details related to an embodiment of one of the controllable ventilation valves 30 is described. The controllable ventilation valve 30 includes a variable orifice 31 that is formed by a moveable flow valve 34 that is inserted into an opening in a valve body 33. The valve body 33 has a nozzle 32 for controlling direction of flow of air through the opening. An air inlet is fluidly coupled to a cabin air supply (not shown), and the nozzle 32 opens into the cabin 10. In one embodiment, the nozzle 32 directs airflow towards one of the passenger seats 14 that are shown with reference to FIG. 1.

A first actuator 35 is coupled to the moveable flow valve 34, and is arranged to control a position of the moveable flow valve 34 in relation to the valve body 33, and thus control size or area of the variable orifice 31 between the moveable flow valve 34 and the valve body 33, to control magnitude of airflow from the nozzle 32. In one embodiment, the first actuator 35 is an electro-mechanical linear actuator.

In one embodiment, a second actuator 38 is coupled to the nozzle 32, and is arranged to control a position of the nozzle 32, and thus control direction of airflow from the nozzle 32 into the cabin 10. In one embodiment, the second actuator 38 is an electro-mechanical actuator that is arranged to control linear movement of the nozzle 32 in a first direction associated with a longitudinal axis of the cabin 10, and control linear movement of the nozzle 32 in a second direction associated with a lateral axis of the cabin 10.

FIG. 4 pictorially illustrates an embodiment of the user interface 27, with continued reference to the ventilation control system 50 including the plurality of controllable ventilation valves 30 that are described with reference to FIGS. 1, 2, and 3. The user interface 27 may be arranged as a hardware user interface with associated electromechanical buttons, or as a GUI that is displayed on a screen of one of the seat control panels 28, and/or displayed on a screen of the personal electronic device 54. The user interface 27 includes a flow control icon 61 (Flow Control); a directional control icon 63 (Direction Control), a reading lamp icon (Lamp) 65, and a service request icon (Call) 67. The flow control icon 61 provides variable flow control between a minimum (MIN) or zero flow rate, and a maximum (MAX) flowrate of the controllable ventilation valve 30 by commanding actuation of the first actuator 35. The directional control icon 63 provides for left/right directional control (LEFT RIGHT), and fore/aft directional control (FORE AFT) of the controllable ventilation valve 30 by commanding actuation of the second actuator 38. The reading lamp icon 65 provides for on/off control (ON OFF) of the reading lamp 22. The service request icon 67 provides for a service request call (CALL) of the service call lamp 24. This arrangement provides for both localized and centralized control of the controllable ventilation valves 30, to control either or both the direction of flow and the quantity of airflow therethrough.

The term “controller” and related terms such as microcontroller, control, control unit, processor, etc. refer to one or various combinations of Application Specific Integrated Circuit(s) (ASIC), Field-Programmable Gate Array(s) (FPGA), electronic circuit(s), central processing unit(s), e.g., microprocessor(s) and associated non-transitory memory component(s) in the form of memory and storage devices (read only, programmable read only, random access, hard drive, etc.). The non-transitory memory component is capable of storing machine readable instructions in the form of one or more software or firmware programs or routines, combinational logic circuit(s), input/output circuit(s) and devices, signal conditioning, buffer circuitry and other components, which can accessed by and executed by one or more processors to provide a described functionality. Input/output circuit(s) and devices include analog/digital converters and related devices that monitor inputs from sensors, with such inputs monitored at a preset sampling frequency or in response to a triggering event. Software, firmware, programs, instructions, control routines, code, algorithms, and similar terms mean controller-executable instruction sets including calibrations and look-up tables. Each controller executes control routine(s) to provide desired functions. Routines may be executed at regular intervals, for example every 100 microseconds during ongoing operation. Alternatively, routines may be executed in response to occurrence of a triggering event. Communication between controllers, actuators and/or sensors may be accomplished using a direct wired point-to-point link, a networked communication bus link, a wireless link, or another communication link. Communication includes exchanging data signals, including, for example, electrical signals via a conductive medium; electromagnetic signals via air; optical signals via optical waveguides; etc. The data signals may include discrete, analog and/or digitized analog signals representing inputs from sensors, actuator commands, and communication between controllers.

In summary, an embodiment of a ventilation control system 50 for an aircraft cabin 10 is described, and includes a plurality of controllable ventilation valves 30 associated with a plurality of passenger seats 14, a plurality of user interfaces 27 associated with the plurality of passenger seats 14, and an aircraft service control panel 40 that in communication with the plurality of controllable ventilation valves 30. The plurality of user interfaces 27 are arranged to individually control the plurality of controllable ventilation valves 30, and the aircraft service control panel 40 is arranged to concurrently control the plurality of controllable ventilation valves 30.

The plurality of user interfaces 27 are accessible on a personal electronic device 54, an in-flight entertainment system 25, or a seat control panel 28 to individually control the plurality of controllable ventilation valves 30.

The plurality of user interfaces 27 may be coupled via a communication bus 56 or WLAN 55 to a respective one of the plurality of controllable ventilation valves 30.

The plurality of user interfaces 27 may be wirelessly coupled to a respective one of the plurality of controllable ventilation valves 30.

Each of the plurality of controllable ventilation valves 30 includes a moveable flow valve 34 that is disposed in a valve body 33 including a nozzle 32. A first actuator 35 is connected to the moveable flow valve 34, and is arranged to control a position of the moveable flow valve 34 in relation to the valve body 33.

A second actuator 38 is arranged to provide directional control of the nozzle 32.

The aircraft service control panel 40 is arranged to concurrently control the plurality of controllable ventilation valves 30 to open states, and is also arranged to concurrently control the plurality of controllable ventilation valves 30 to closed states.

The aircraft service control panel 40 is arranged to concurrently control a subset of the plurality of controllable ventilation valves 30 to open states, and is also arranged to concurrently control a subset of the plurality of controllable ventilation valves 30 to closed states.

The aircraft service control panel 40 is disposed in a service area 45 of the aircraft cabin 10.

The aircraft service control panel 40 may be disposed in a service area of the aircraft 100 that is externally accessible, i.e., is located outside the cabin 10. In one embodiment, this may include the aircraft service control panel 40 being disposed beneath an outer skin of the aircraft and accessible via a securable hatch.

Another embodiment of the ventilation control system 50 for the aircraft cabin 10 includes a plurality of controllable ventilation valves 30 associated with a plurality of passenger seats 14, and a control panel 40 in communication with the plurality of controllable ventilation valves 30, wherein the control panel 40 is arranged to concurrently control the plurality of controllable ventilation valves 30.

The components of the disclosed embodiments, as described and illustrated herein, may be arranged and designed in a variety of different configurations. Thus, the detailed description is not intended to limit the scope of the disclosure, as claimed, but is merely representative of possible embodiments thereof. In addition, while numerous specific details are set forth in the following description in order to provide a thorough understanding of the embodiments disclosed herein, some embodiments can be practiced without some of these details. Moreover, for the purpose of clarity, certain technical material that is understood in the related art has not been described in detail in order to avoid unnecessarily obscuring the disclosure. Furthermore, the drawings are in simplified form and are not to precise scale. For purposes of convenience and clarity only, directional terms such as top, bottom, left, right, up, over, above, below, beneath, rear, and front, may be used with respect to the drawings. These and similar directional terms are not to be construed to limit the scope of the disclosure. Furthermore, the disclosure, as illustrated and described herein, may be practiced in the absence of an element that is not specifically disclosed herein.

Furthermore, the detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the appended claims.

1. A ventilation control system for an aircraft cabin, the ventilation control system comprising:
a plurality of controllable ventilation valves associated with a plurality of passenger seats;
a plurality of user interfaces associated with the plurality of passenger seats; and
an aircraft service control panel in communication with the plurality of controllable ventilation valves;
wherein the plurality of user interfaces are arranged to individually control the plurality of controllable ventilation valves; and
wherein the aircraft service control panel is arranged to concurrently control the plurality of controllable ventilation valves.

2. The ventilation control system of claim 1, wherein the plurality of user interfaces are accessible on a personal electronic device, an in-flight entertainment system, or a seat control panel to individually control the plurality of controllable ventilation valves.

3. The ventilation control system of claim 1, further comprising the plurality of user interfaces being coupled via a communication bus to a respective one of the plurality of controllable ventilation valves.

4. The ventilation control system of claim 1, further comprising the plurality of user interfaces being wirelessly coupled to a respective one of the plurality of controllable ventilation valves.

5. The ventilation control system of claim 1, wherein each of the plurality of controllable ventilation valves comprises:
a moveable flow valve disposed in a valve body including a nozzle; and
a first actuator connected to the moveable flow valve;
wherein the first actuator is arranged to control a position of the moveable flow valve in relation to the valve body.

6. The ventilation control system of claim 5, further comprising a second actuator arranged to provide directional control of the nozzle.

7. The ventilation control system of claim 1, wherein the aircraft service control panel is arranged to concurrently control the plurality of controllable ventilation valves to open states, and wherein the aircraft service control panel is arranged to concurrently control the plurality of controllable ventilation valves to closed states.

8. The ventilation control system of claim 1, wherein the aircraft service control panel is arranged to concurrently control a subset of the plurality of controllable ventilation valves to open states, and wherein the aircraft service control panel is arranged to concurrently control a subset of the plurality of controllable ventilation valves to closed states.

9. The ventilation control system of claim 1, wherein the aircraft service control panel is disposed in a service area of the aircraft cabin.

10. The ventilation control system of claim 1, wherein the aircraft service control panel is disposed in a service area of the aircraft that is externally accessible.

11. A ventilation control system for controlling airflow in an aircraft cabin, the ventilation control system comprising:
a plurality of controllable ventilation valves associated with a plurality of passenger seats; and
a control panel in communication with the plurality of controllable ventilation valves, wherein the control panel is arranged to concurrently control the plurality of controllable ventilation valves.

12. The ventilation control system of claim 11, wherein the control panel is coupled via a communication bus with the plurality of controllable ventilation valves.

13. The ventilation control system of claim 11, wherein the control panel is coupled with the plurality of controllable ventilation valves via a wireless routing system.

14. The ventilation control system of claim 11, wherein each of the plurality of controllable ventilation valves comprises:
a moveable flow valve disposed in a valve body including a nozzle; and
an electro-mechanical actuator connected to the moveable flow valve;
wherein the electro-mechanical actuator is arranged to control a position of the moveable flow valve in relation to the valve body to control an orifice opening between the moveable flow valve and the valve body.

15. The ventilation control system of claim 11, wherein the control panel is arranged to concurrently control the plurality of controllable ventilation valves to fully-opened states.

16. The ventilation control system of claim 11, wherein the control panel is arranged to concurrently control the plurality of controllable ventilation valves to closed, no-flow states.

17. The ventilation control system of claim 11, wherein the control panel is disposed in a service area of the aircraft cabin.

18. The ventilation control system of claim 11, wherein the control panel is disposed in a service area of the aircraft that is externally accessible.

19. The ventilation control system of claim 11, further comprising a plurality of user interfaces arranged to control a respective one of the plurality of controllable ventilation valves.

20. The ventilation control system of claim 19, wherein the plurality of user interfaces are accessible on a personal electronic device, an in-flight entertainment system, or a seat control panel.
